(19) United States
(12) Patent Application Publication
(10) Pub. No.: US 2007/0266509 A1
(43) Pub. Date: Nov. 22, 2007

(54) Device for Cleaning a Hollow Vessel

(76) Inventors: Gregor Kohlruss, Rhede (DE); Hubert Wiesner, Sudlohn (DE); Oliver Griebe, Rhede (DE)

Correspondence Address: WILLIAM COLLARD;COLLARD & ROE, P.C., 1077 NORTHERN BOULEVARD, ROSLYN, NY, 11576, US

(21) Appl. No.: 10/590,130

(22) PCT Filed: Feb. 18, 2005
(86) PCT No.: PCT/EP05/01708

§ 371 Date: Dec. 19, 2006

(30) Foreign Application Priority Data
Feb. 20, 2004 (DE) 10 2004 008 829.2

(51) Int. Cl. B08B 9/00

(52) U.S. Cl. 15/104.94

(57) ABSTRACT

The invention relates to a device for cleaning a hollow vessel (6) that has a narrow neck at the top and below it a radially widened cavity, having a handle (1) and a cleaning head (2) that can be passed through the narrow neck of the hollow vessel (6), which head is provided with cleaning material and can be spread open in the interior of the cavity. In order for the cleaning head to be able to be better adapted to the contours of the hollow vessel in the case of such a device, and in order to achieve an improved cleaning effect, the invention proposes that the cleaning head (2) consists of an extensively rigid loop (3) of elastic material that extends in the insertion direction, which loop is covered with cleaning material and bends outward when it hits the bottom of the hollow vessel (6), and rests against the bottom and the walls of the hollow vessel (6) when doing so, adapting to their contour.

The invention relates to a device for cleaning a hollow vessel that has a narrow neck at the top and below it a radially widened cavity, having a handle and a cleaning head that can be passed through the narrow neck of the hollow vessel, which head is provided with cleaning material and can be spread open in the interior of the cavity.

Cleaning devices of the type stated are known, for example, from Swiss patent 43 06, Swiss patent 24 204, or Swiss patent 167 467. In the case of the previously known cleaning devices, the cleaning head is configured as a multi-part brush head, which can be spread open by means of a corresponding activation mechanism. In this way, the parts of the bristle head lie against the walls of the hollow vessel, which can be intensively cleaned in this manner.

The previously known devices are particularly suitable for bottles or similar hollow vessels. They are less well suited if the important thing is to clean a hollow vessel that has a very great radial doming, as is the case for decanting vessels for red wine, for example. Here, the rigidly structured parts of the brush head can no longer sufficiently adapt to the bulging of the walls.

It is therefore the task of the invention to further develop the device of the type stated initially, in such a manner that the cleaning head can better adapt to the contours of the hollow vessel, in order to achieve an improved cleaning effect.

To accomplish this task, the invention proposes, proceeding from a device of the type stated initially, that the cleaning head consists of at least one extensively rigid loop of elastic material that extends in the insertion direction, which loop is covered with cleaning material and bends outward when it hits the bottom of the vessel, and rests against the bottom and the walls of the hollow vessel when doing so, adapting to their contour.

When using the device according to the invention, the lower end of the loop is first bent tightly together, so that the loop can be introduced into the hollow vessel from above, through the narrow neck of the hollow vessel, until the loop hits against the bottom of the hollow vessel. When the loop is pushed further into the hollow vessel, the loop bends radially outward because of its impact on the bottom, and lays itself against the bottom and the walls of the hollow vessel when doing so. Because of its elasticity, the loop adapts completely to the contours of the bottom and the walls. On its outside, the loop is covered with a suitable cleaning material. This cleaning material can be a suitable cleaning plush, for example. By means of turning the vessel relative to the loop, the bottom and the walls of the hollow vessel are intensively cleaned or dried.

It is practical if the loop consists of a flat plastic strip, which is connected with the cleaning material. The flat plastic strip allows relatively large contact surfaces on the walls and the bottom of the vessel to be cleaned. Furthermore, such a strip best transfers the forces and moments to be transferred during the cleaning work, without losing the ability to adapt to the contours of the hollow vessel.

An even better adaptation possibility and even better handling result if the plastic strip of the loop has a greater bending resistance in the regions subject to less bending stress than in the regions subject to greater bending stress. In this manner, it is possible to optimally adapt the loop that serves as a cleaning head to the progression of the vessel to be cleaned.

The greater bending resistance in certain regions of the loop is achieved, in practical manner, in that the plastic strip is configured in two or more layers there.

It is practical if the cleaning material is configured as a replaceable sleeve that is drawn over the plastic strip. In this manner, the cleaning material can easily be cleaned elsewhere, for example in a washing machine, and replaced if necessary.

If the primary concern is mechanical cleaning of the walls of the hollow vessel, the cleaning material is provided, on the outside, with textile fibers that have a scrubbing effect. However, if the device is supposed to be used to wipe the inside wall of the hollow vessel dry, without leaving spots, the cleaning material consists, on the outside, of textile fibers having a drying effect.

An exemplary embodiment of the invention will be explained in greater detail in the following, using the drawings. These show:

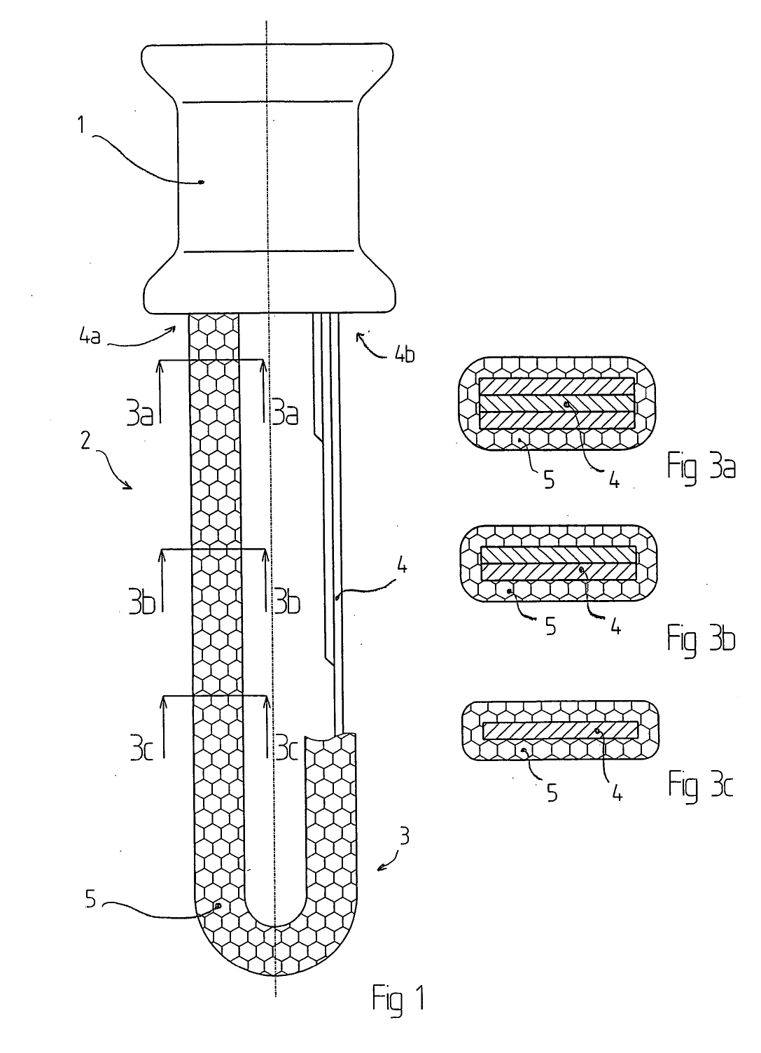

FIG. 1: the device according to the invention schematic side view;

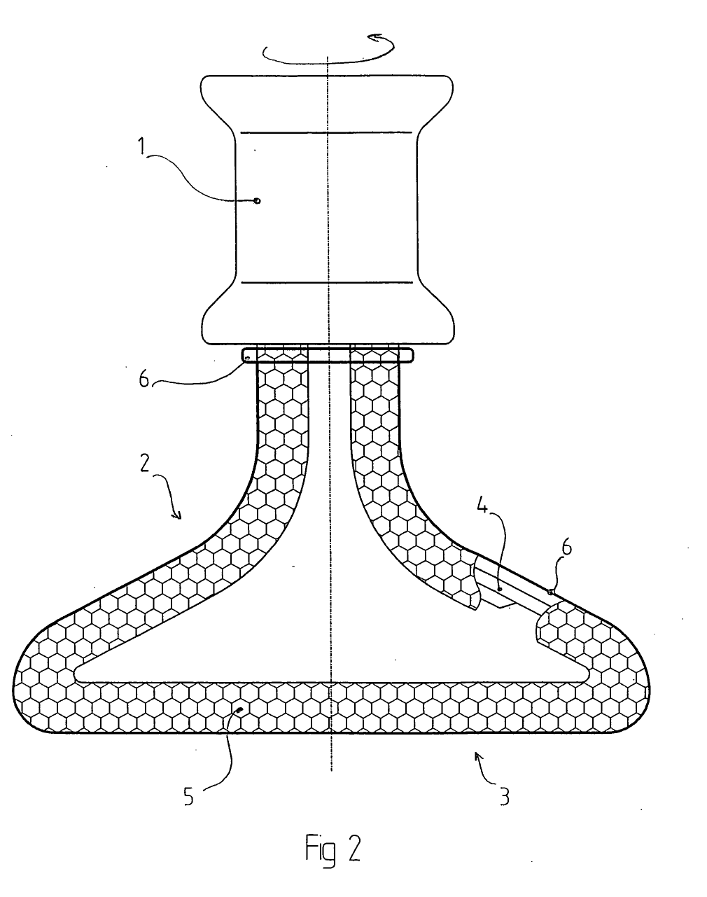

FIG. 2: the device according to FIG. 1 when cleaning a decanting vessel;

FIG. 3a, 3b, 3c: sections through the plastic strip that forms the loop, in one layer, two layers, and three layers.

In the drawing, the handle of the cleaning device is designated with the reference symbol 1, and the cleaning head with the reference symbol 2. The cleaning head 2 has a loop 3 that is produced from a flat plastic strip 4, which is attached to the handle 1 with its two ends 4a and 4b.

In its region that directly follows the handle, the plastic strip 4 is configured in three layers, and for this reason has a relatively great rigidity there. In the following regions, in contrast, the plastic strip 4 is configured in two layers (see FIG. 3b), and therefore has a moderate rigidity there. At the lower end of the loop 3, in contrast, the plastic strip 4 is configured in one layer, and therefore has the lowest rigidity there.

On the outside, the plastic strip 4 is surrounded by a sleeve 5 made of a cleaning textile, for example a cleaning plush. This sleeve 5 can be pulled off the plastic strip 4, and cleaned separately, or replaced. To loosen contaminants from the wall of the hollow vessel to be cleaned, this sleeve 5 is provided with scrubbing textile fibers on the outside. Alternatively or in addition, the sleeve 5 can also be provided with dry textile fibers, for the purpose of drying.

As is evident from FIG. 2, the cleaning head 2, configured as a loop 3, will be introduced into the hollow vessel 6 to be cleaned (here, a red wine decanting vessel), from above. As soon as the loop 3 hits the bottom of the hollow vessel 6 with its lower end, the shanks of the loop 3 bend outward. When the loop 3 is pushed further into the narrow neck of the hollow vessel 6, the elastic shanks of the loop 2 lie against the bottom and the walls of the hollow vessel 6, and adapt to their contour when doing so.

To clean the hollow vessel 6, a relative rotary motion between the cleaning device, on the one hand, and the hollow vessel 6, on the other hand, is then generated. If the sleeve 5 is equipped with scrubbing fibers, contaminants on the walls or the floor of the hollow vessel 6 are mechanically loosened in doing so. If, on the other hand, the sleeve 5 is equipped with drying textile fibers, the walls and the bottom of the hollow vessel can be dried in this manner, without leaving smears.

To clean the sleeve 5, it can be pulled off the plastic strip 4 and washed separately, for example in a washing machine.

1: Device for cleaning a hollow vessel (6) that has a narrow neck at the top and below it a radially widened cavity, having a handle (1) and a cleaning head (2) that can be passed through the narrow neck of the hollow vessel (6), which head is provided with cleaning material and can be spread open in the interior of the cavity, wherein the cleaning head (2) consists of an extensively rigid loop (3) of elastic material that extends in the insertion direction, which loop is covered with cleaning material and bends outward when it hits the bottom of the hollow vessel (6), and rests against the bottom and the walls of the hollow vessel (6) when doing so, adapting to their contour.

2: Device according to claim 1, wherein the loop (3) consists of a flat plastic strip (4) that is connected with the cleaning material.

3: Device according to claim 1, wherein the plastic strip (4) of the loop (3) has a greater bending resistance in the regions subject to less bending stress than in the regions subject to greater bending stress.

4: Device according to claim 3, wherein the plastic strip (4) is configured in two or more layers in the regions of greater bending resistance.

5: Device according to claim 2, wherein the cleaning material is configured as a sleeve (5) pulled over the plastic strip (4) in replaceable manner.

6: Device according to claim 5, wherein the cleaning material is provided, on the outside, with textile fibers having a scrubbing effect.

7: Device according to claim 5, wherein the cleaning material is provided, on the outside, with textile fibers having a drying effect.
